(19) United States
(12) Patent Application Publication
(10) Pub. No.: US 2012/0156391 A1
(43) Pub. Date: Jun. 21, 2012

(54) PROCESS FOR PRODUCING ELECTRICALLY CONDUCTIVE SURFACES

(75) Inventors: Frank Kleine Jaeger, Bad Duerkheim (DE); Juergen Kaczun, Wachenheim (DE); Udo Lehmann, Waldalgesheim (DE)

(73) Assignee: BASF SE, Ludwigshafen (DE)

(21) Appl. No.: 13/391,779

(22) PCT Filed: Aug. 24, 2010
(86) PCT No.: PCT/EP10/62311

§ 371 Date: Feb. 22, 2012

(30) Foreign Application Priority Data
Sep. 4, 2009 (EP) 09 169 550..2

(51) Int. Cl. B29B 13/08

(52) U.S. Cl. 427/547

(57) ABSTRACT

The invention relates to a process for producing structured or full-area, electrically conductive surfaces on a substrate (1), comprising the following steps:
(a) transferring electrolessly and/or electrolytically coatable particles or a dispersion (3) comprising electrolessly and/or electrolytically coatable particles from a transfer medium (5) onto the substrate (1),
(b) fixing the electrolessly and/or electrolytically coatable particles on the substrate (1),
   wherein the transfer in step (a) is promoted by virtue of the particles being magnetic or magnetizable or, in the case of transfer or a dispersion, magnetic or magnetizable particles being present in the dispersion, and a magnetic field (9) is applied.

The invention relates to a process for producing structured or full-area, electrically conductive surfaces on a substrate, comprising the following steps:

(a) transferring electrolessly and/or electrolytically coatable particles or a dispersion comprising electrolessly and/or electrolytically coatable particles from a transfer medium onto the substrate,

(b) fixing the electrolessly and/or electrolytically coatable particles on the substrate.

Structured or full-area, electrically conductive surfaces on a substrate which can be produced by the process according to the invention are, for example, conductor tracks on printed circuit boards, RFID antennas, transponder antennas or other antenna structures, chip card modules, flat cables, seat heaters, foil conductors, conductor tracks in LCD or plasma visual display units, or electrocoatable products in any form. It is also possible for the structured or full-area surfaces to be used as decorative or functional surfaces on products which are used for shielding of electromagnetic radiation, for conduction of heat or as packaging.

In general, structured or full-area, electrically conductive surfaces are produced by first applying a structured or full-area adhesive layer to an electrically nonconductive carrier. A metal foil or a metal powder is fixed on this adhesive layer. Alternatively, it is also known to apply a metal foil or a metal layer to the whole area of a carrier body made from a polymer material, and to press it against the carrier body by means of a structured, heated die and to fix it by subsequent curing. The metal layer is structured by mechanical removal of the region of the metal foil or of the metal powder not bonded to the adhesive layer or to the carrier body. Such a process is described, for example, in DE-A 101 45 749. A disadvantage of this process is, however, that a large amount of material has to be removed again after the application of the base layer, some of which additionally cannot be reused. In the case of the metal foil, it is impossible to generate sharp edges since the film cannot be transferred in a corresponding manner. These sharp edges are, however, needed, for example, for production of conductor tracks for printed circuit boards or RFID antennas, for example. A film which has not been divided cleanly would, for example, cause short circuits. In the case of the mechanical removal of the excess metal powder or of the excess foil, it is also possible for conductor track structures to be partly removed, as a result of which these conductor tracks no longer function.

EP-A 0 130 462 discloses applying a layer of a heat-curing resin with metal particles present therein, at least some of the particles consisting of a noble metal, onto a transfer surface in a structured manner. Subsequently, the transfer medium, by the side on which the layer comprising the resin and the metal particles is applied, is contacted with a carrier body. This involves applying an adhesive layer either to the layer comprising the metal particles or to the carrier body, in such a way that the layer comprising the metal particles is transferred to the carrier body in the form of the structured surface to be produced.

However, a disadvantage of this process is the size of the metal particles used, in the range from 150 to 420 μm, which do not enable generation of ultrafine conductor track structures, i.e. conductor tracks smaller than 100 μm. In addition, the process proposed requires a significant proportion of an expensive noble metal such as silver. A further disadvantage is the use of a highly metal-filled printing ink, which is very difficult to print with high resolution. Moreover, an unnecessarily large amount of metal is transferred, since all of the metal-filled printing ink layer is transferred from the intermediate carrier to the substrate, even though only a thin metal layer on the surface is required later in the process. When the structured metal-containing printing ink is transferred from the intermediate carrier to the substrate, there is the risk that thin conductor track structures are not transferred at the same time, which therefore results in defects in the conductor track. A further disadvantage of the process is that, before the structured metal-containing layer is transferred, an additional compaction step is required before the transfer of the metal layer to the substrate, in order to achieve sufficient conductivity for the subsequent electrocoating.

A further process in which electrolessly and/or electrolytically coatable particles from a dispersion comprising electrolessly and/or electrolytically coatable particles are transferred from a transfer medium to the substrate and the particles are fixed on the substrate is known from WO-A 2008/055867. However, a disadvantage here too is that the print quality resulting from the printing process depends to a high degree on the homogeneity of the parameters involved in the process.

It is an object of the present invention to provide a process for producing structured or full-area, electrically conductive surfaces on a substrate, in which fine structures with clean edges can also be printed.

The object is achieved by a process for producing structured or full-area, electrically conductive surfaces on a substrate, comprising the following steps:
(a) transferring electrolessly and/or electrolytically coatable particles or a dispersion comprising electrolessly and/or electrolytically coatable particles from a transfer medium onto the substrate,
(b) fixing the electrolessly and/or electrolytically coatable particles on the substrate,
   wherein the particles are magnetic or magnetizable or, in the case of transfer of a dispersion, magnetic or magnetizable particles are present in the dispersion, and the transfer in step (a) is promoted by applying a magnetic field.

As a result of the application of the magnetic field, the electrolessly and/or electrolytically coatable particles or droplets of the dispersion which comprises the electrolessly and/or electrolytically coatable particles are transferred in a more controlled and direct manner to the substrate. This allows an improved print quality to be achieved compared to the processes known from the prior art.

The electrolessly and/or electrolytically coatable particles or the dispersion comprising the electrolessly and/or electrolytically coatable particles is transferred preferably by introducing energy from an apparatus for introducing energy through the transfer medium into the particles or the dispersion. In this case, the transfer medium and the substrate to be printed are not in contact. The application of the magnetic field, in spite of the distance between the transfer medium and the substrate to printed, improves the printed image.

The distance between transfer medium and substrate to be printed is generally referred to as print gap. The print gap preferably has a gap width of 0 to 2 mm, more preferably in the range from 0.01 to 1 mm and especially in the range from 0.05 to 0.5 mm. The smaller the print gap between the transfer medium and the substrate, the less the spread of droplets when they hit the substrate to be printed and the more homogeneous the printed image remains. In setting the print gap, however, it should be ensured that the substrate to be printed, which is coated with the electrolessly and/or electrolytically coatable particles or with the dispersion comprising the electrolessly and/or electrolytically coatable particles, does not come into contact with the transfer medium, in order that particles or dispersion comprising the particles is not transferred to the substrate to be printed at undesired sites.

The transfer medium used is preferably a flexible carrier. In this case, the transfer medium is preferably configured in ribbon form. The transfer medium is more preferably a film. The thickness of the transfer medium is preferably in the range from 1 to approx. 500 μm, especially in the range from 10 to 200 μm. It is advantageous to configure the transfer medium in a minimum thickness, in order that the energy introduced by the transfer medium is not scattered within the transfer medium, thus generating a clean printed image. Suitable materials for the transfer medium are, for example, polymer films transparent to the energy used or a glass cylinder.

In one embodiment of a printing machine suitable for the process according to the invention, the transfer medium is stored in a suitable device. For example, it is possible for this purpose that the transfer medium which has been coated with the electrolessly and/or electrolytically coatable particles or the dispersion comprising the electrolessly and/or electrolytically coatable particles has been wound up to a roll. For printing, the coated transfer medium is unwound and conducted through a print area in which, with the aid of the energy, electrolessly and/or electrolytically coatable particles or dispersion comprising the particles is transferred to the substrate to be printed. Subsequently, the transfer medium is, for example, wound up again onto a roll which can then be disposed of. It is preferred, however, that the transfer medium is configured as a continuous ribbon. In this case, the particles or the dispersion comprising the particles is applied to the transfer medium with a suitable application device before it reaches the print position, i.e. the site at which the particles or the dispersion comprising the particles are transferred from the transfer medium to the substrate to be printed with the aid of the energy input. After the printing operation, some of the particles or of the dispersion comprising the particles has been transferred from the carrier to the substrate. As a result, there is no longer a homogeneous film on the carrier. For a next printing operation, it is thus necessary again to apply particles or a dispersion comprising particles to the carrier. This is done, for example, the next time the corresponding position passes through a color application device. In order to prevent—especially in the case of use of a dispersion—the dispersion from partly drying on the flexible carrier and in order to obtain a homogeneous layer on the transfer medium in each case, it is advantageous first to remove the particles present on the transfer medium or the dispersion before a subsequent application of particles or a dispersion comprising particles to the transfer medium. The removal can be effected, for example, with the aid of a roll or a coating knife. When a roll is used to remove the particles or the dispersion, it is possible that the same roll with which the particles or the dispersion is also applied to the carrier is used. For this purpose, it is advantageous when the rotating motion of the roll is in the opposite direction to the motion of the transfer medium. The particles removed from the transfer medium or the dispersion removed can then be fed back to a reservoir. When a roll for removing the particles or the dispersion is provided, it is of course alternatively also possible that one roll is provided for removing the particles or the dispersion and one roll for applying the particles or the dispersion.

When the particles or the dispersion comprising the particles are to be removed from the transfer medium with a coating knife, it is possible to use any desired coating knife known to those skilled in the art.

In order to prevent the transfer medium from being damaged on application of the particles or of the dispersion comprising the particles or on removal of the particles or of the dispersion comprising the particles, it is preferred when the transfer medium is pressed with the aid of a counter-roll against the application roll with which the particles or the dispersion comprising particles is applied to the transfer medium, or the roll with which the particles or the dispersion comprising particles is removed from the transfer medium, or the coating knife with which the particles or the dispersion comprising particles is removed from the transfer medium. The opposing pressure is adjusted such that the particles or the dispersion comprising the particles is removed essentially completely, but there is no damage to the transfer medium.

The energy is preferably introduced into the particles or the dispersion comprising particles in a focused manner through the transfer medium. This allows an improvement in the printed image to be achieved. The size of the dot onto which the energy to be introduced is focused corresponds to the size of the dot to be transferred as a function of the substrate. In general, dots to be transferred have a diameter of approx. 20 μm to approx. 200 μm. However, the size of the dot to be transferred may vary as a function of the substrate to be printed and the printed product thus to be produced. For example, it is possible, especially in the case of production of printed circuit boards, to select a greater focus. In contrast, in printed products in which lettering is shown, generally smaller printed dots are preferred to obtain a clear lettering image. In the case of printing of images and graphics too, it is advantageous to print very small dots in order to obtain a clear image.

The energy which is used to transfer the particles or the dispersion comprising particles to the substrate to be printed is preferably a laser. The advantage of a laser is that the laser beam used can be focused to a very small cross section. Targeted energy input is thus possible. The particles or the dispersion comprising the particles is transferred by at least partial evaporation, as a result of which the particles or the dispersion comprising particles are detached from the transfer medium and transferred to the substrate. It is necessary for this purpose to convert the light from the laser to heat. This can be done firstly by virtue of the particles or the dispersion comprising the particles comprising a suitable absorber which absorbs the laser light and converts it to heat. Alternatively, it is also possible that the transfer medium is coated with an appropriate absorber or is manufactured from such an absorber, or comprises such an absorber which absorbs the laser light and converts it to heat. It is preferred, however, that the transfer medium is manufactured from a material transparent to the laser radiation and the absorber which converts the laser light to heat is present in the particles or in the dispersion comprising the particles.

Suitable absorbers are, for example, carbon particles in the form of carbon black, graphite, carbon nanotubes or graphenes, nanoparticulate metals, for example silver nanoparticles, metal nitrides, metal oxides or fine lanthanum hexaboride with particle sizes in the range from 0.01 to 1 μm, preferably in the range from 0.02 to 0.5 μm and especially in the range from 0.03 to 0.2 μm.

The laser used to introduce the energy may be any desired laser known to those skilled in the art. Preference is given to using a solid-state laser, a fiber laser, a diode laser, a gas laser or an excimer laser. The laser used preferably generates a laser beam with a wavelength in the range from 150 to 10 600 nm, especially in a range from 600 to 1200 nm.

When a dispersion is used for coating, the electrolessly and/or electrolytically coatable particles to be transferred to the substrate may be particles with any desired geometry composed of any desired electrolessly and/or electrolytically coatable material, composed of mixtures of different electrolessly and/or electrolytically coatable materials or else composed of mixtures of electrolessly and/or electrolytically coatable and electrolessly and/or electrolytically noncoatable materials. Suitable electrolessly and/or electrolytically coatable materials are, for example, carbon, for example in the form of carbon black, graphite, carbon nanotubes or graphenes, electrically conductive metal complexes, conductive organic compounds or conductive polymers or metals, preferably zinc, nickel, copper, tin, cobalt, manganese, iron, magnesium, lead, chromium, bismuth, silver, gold, aluminum, titanium, palladium, platinum, tantalum and alloys thereof, or metal mixtures which comprise at least one of these metals. Suitable alloys are, for example, CuZn, CuSn, CuNi, SnPb, SnBi, SnCo, NiPb, ZnFe, ZnNi, ZnCo and ZnMn. Especially preferred materials for the electrolessly and/or electrolytically coatable particles are aluminum, iron, copper, nickel, zinc, carbon and mixtures thereof.

It is particularly preferred when the electrolessly and/or electrolytically coatable particles comprise a magnetizable material or are magnetic. Suitable materials are, for example, metals such as iron, nickel, cobalt or alloys such as NiFe, NiCuCo, NiCoFe, AlNi, AlNiCo, FeCoV, FeCo, FeSi, MnAICu₂, SmCo and Nd₂Fe₁₄B.

The electrolessly and/or electrolytically coatable particles preferably have a mean particle diameter of 0.001 to 100 μm, preferably of 0.005 to 50 μm and especially preferably of 0.01 to 10 μm. The mean particle diameter can be determined by means of laser diffraction analysis, for example using a Microtrac X100 instrument. The distribution of the particle diameter depends on the production process thereof. Typically, the diameter distribution has only one maximum, but several maxima are also possible.

The surface of the electrolessly and/or electrolytically coatable particles may be at least partly provided with a coating. Suitable coatings may be inorganic (for example SiO₂, phosphates) or organic in nature. It will be appreciated that the electrolessly and/or electrolytically coatable particles may also be coated with a metal or metal oxide. The metal may likewise be present in partly oxidized form.

If two or more different types of electrolessly and/or electrolytically coatable particles are to be used, this can be done by means of a mixture of these types. It is especially preferred when the types are selected from the group consisting of iron, nickel, cobalt, FeNi and FeNiCo.

The electrolessly and/or electrolytically coatable particles may, however, also comprise a first metal and a second metal, in which case the second metal is present in the form of an alloy (with the first metal or one or more other metals), or the electrolessly and/or electrolytically coatable particles comprise two different alloys.

When the electrolessly and/or electrolytically coatable particles used in the dispersion are not magnetic or magnetizable, the dispersion additionally comprises particles which comprise a magnetic or magnetizable material. It is preferred, however, when the electrolessly and/or electrolytically coatable particles used comprise a magnetic or magnetizable material.

If no dispersion but rather only particles are transferred, the particles in accordance with the invention comprise a magnetic or magnetizable material.

When a dispersion which comprises the electrolessly and/or electrolytically coatable particles is used, it further comprises at least one solvent and a binder as a matrix material. In addition, the dispersion may comprise further additives, for example suitable absorbers, dispersing aids and leveling aids, corrosion inhibitors, etc.

Suitable solvents are, for example, aliphatic and aromatic hydrocarbons (for example n-octane, cyclohexane, toluene, xylene), alcohols (for example methanol, ethanol, 1-propanol, 2-propanol, 1-butanol, 2-butanol, amyl alcohol), polyhydric alcohols such as glycerol, ethylene glycol, propylene glycol, neopentyl glycol, alkyl esters (for example methyl acetate, ethyl acetate, propyl acetate, butyl acetate, isobutyl acetate, isopropyl acetate, 3-methylbutanol), alkoxy alcohols (for example methoxypropanol, methoxybutanol, ethoxypropanol), alkylbenzenes (for example ethylbenzene, isopropylbenzene), butyl glycol, butyl diglycol, alkyl glycol acetates (for example butyl glycol acetate, butyl diglycol acetate), diacetone alcohol, diglycol dialkyl ethers, diglycol monoalkyl ethers, dipropylene glycol dialkyl ethers, dipropylene glycol monoalkyl ethers, diglycol alkyl ether acetates, dipropylene glycol alkyl ether acetates, dioxane, dipropylene glycol and ethers, diethylene glycol and ethers, DBE (dibasic esters), ethers (for example diethyl ether, tetrahydrofuran), ethylene chloride, ethylene glycol, ethylene glycol acetate, ethylene glycol dimethyl ester, cresol, lactones (for example butyrolactone), ketones (for example acetone, 2-butanone, cyclohexanone, methyl ethyl ketone (MEK), methyl isobutyl ketone (MIBK)), methyl diglycol, methylene chloride, methylene glycol, methyl glycol acetate, methylphenol (ortho-, meta-, para-cresol), pyrrolidones (for example N-methyl-2-pyrrolidone), propylene glycol, propylene carbonate, carbon tetrachloride, toluene, trimethylolpropane (TMP), aromatic hydrocarbons and mixtures, aliphatic hydrocarbons and mixtures, alcoholic monoterpenes (for example terpineol), water and mixtures of two or more of these solvents.

Preferred solvents are alcohols (for example ethanol, 1-propanol, 2-propanol, butanol), alkoxy alcohols (for example methoxypropanol, ethoxypropanol, butyl glycol, butyl diglycol), butyrolactone, diglycol dialkyl ethers, diglycol monoalkyl ethers, dipropylene glycol dialkyl ethers, dipropylene glycol monoalkyl ethers, esters (for example ethyl acetate, butyl acetate, butyl glycol acetate, butyl diglycol acetate, diglycol alkyl ether acetates, dipropylene glycol alkyl ether acetates, DBE), ethers (for example tetrahydrofuran), polyhydric alcohols such as glycerol, ethylene glycol, propylene glycol, neopentyl glycol, ketones (for example acetone, methyl ethyl ketone, methyl isobutyl ketone, cyclohexanone), hydrocarbons (for example cyclohexane, ethylbenzene, toluene, xylene), N-methyl-2-pyrrolidone, water and mixtures thereof.

Mixtures of water and organic solvents are also possible.

The matrix material is preferably a polymer or a polymer mixture.

Preferred polymers as matrix material are ABS (acrylonitrile-butadiene-styrene); ASA (acrylonitrile-styrene-acrylate); acrylated acrylates; alkyd resins; alkylvinyl acetates; alkylene-vinyl acetate copolymers, in particular methylene-vinyl acetate, ethylene-vinyl acetate, butylene-vinyl acetate; alkylene-vinyl chloride copolymers; amino resins; aldehyde and ketone resins; cellulose and cellulose derivatives, in particular hydroxyalkylcellulose, cellulose esters, such as acetates, propionates, butyrates, carboxyalkylcelluloses, cellulose nitrate; epoxy acrylates; epoxy resins; modified epoxy resins, for example bifunctional or polyfunctional bisphenol A or bisphenol F resins, epoxy novolak resins, brominated epoxy resins, cycloaliphatic epoxy resins; aliphatic epoxy resins, glycidyl ethers, vinyl ethers, ethylene-acrylic acid copolymers; hydrocarbon resins; MABS (transparent ABS comprising acrylate units); melamine resins, maleic anhydride copolymers; methacrylates; natural rubber; synthetic rubber; chlorinated rubber; natural resins; rosins; shellac; phenolic resins; polyesters; polyester resins such as phenyl ester resins; polysulfones; polyether sulfones; polyamides; polyimides; polyanilines; polypyrroles; polybutylene terephthalate (PBT); polycarbonate (for example Makrolon® from Bayer AG); polyester acrylates; polyether acrylates; polyethylene; polyethylenethiophenes; polyethylene naphthalates; polyethylene terephthalate (PET); polyethylene terephthalate-glycol (PETG); polypropylene; polymethyl methacrylate (PMMA); polyphenylene oxide (PPO); polystyrenes (PS), polytetrafluoroethylene (PTFE); polytetrahydrofuran; polyethers (for example polyethylene glycol, polypropylene glycol), polyvinyl compounds, in particular polyvinyl chloride (PVC), PVC copolymers, PVdC, polyvinyl acetate and copolymers thereof, optionally partially hydrolyzed polyvinyl alcohol, polyvinyl acetals, polyvinyl acetates, polyvinylpyrrolidone, polyvinyl ethers, polyvinyl acrylates and methacrylates in solution and as dispersion and also copolymers thereof, polyacrylic esters and polystyrene copolymers; polystyrene (impact-modified or not impact-modified); polyurethanes, uncrosslinked or isocyanate-crosslinked; polyurethane acrylates; styrene-acrylic copolymers; styrene-butadiene block copolymers (for example Styroflex® or Styrolux® from BASF AG, K-Resin™ from CPC); proteins such as casein; SIS; triazine resin, bismaleimide-triazine resin (BT), cyanate ester resin (CE), allylated polyphenylene ether (APPE). It is also possible for mixtures of two or more polymers to form the matrix material.

Particularly preferred polymers as matrix material are acrylates, acrylate resins, cellulose derivatives, methacrylates, methacrylate resins, melamine and amino resins, polyalkylenes, polyimides, epoxy resins, modified epoxy resins, for example bifunctional or polyfunctional bisphenol A or bisphenol F resins, epoxy novolak resins, brominated epoxy resins, cycloaliphatic epoxy resins; aliphatic epoxy resins, glycidyl ethers, vinyl ethers and phenolic resins, polyurethanes, polyesters, polyvinyl acetals, polyvinyl acetates, polystyrenes, polystyrene copolymers, polystyrene acrylates, styrene-butadiene block copolymers, alkylene-vinyl acetate and vinyl chloride copolymers, polyamides and copolymers thereof.

In the case of production of printed circuit boards, the matrix materials used for the dispersion are preferably thermally curing or radiation-curing resins, for example modified epoxy resins such as bifunctional or polyfunctional bisphenol A or bisphenol F resins, epoxy novolak resins, brominated epoxy resins, cycloaliphatic epoxy resins; aliphatic epoxy resins, glycidyl ethers, cyanate esters, vinyl ethers, phenolic resins, polyimides, melamine resins and amino resins, polyurethanes, polyesters and cellulose derivatives.

It is additionally preferred when the dispersion comprises an absorbent, for example carbon black, nanoparticulate metals such as silver nanoparticles, metal nitrides, metal oxides or fine lanthanum hexaboride with particle sizes of 0.01 to 1 μm, preferably 0.02 to 0.5 μm and especially 0.03 to 0.2 μm.

If a dispersion is to be printed onto the substrate, it is advantageous when the dispersion comprises magnetic or magnetizable particles. It is possible here firstly that the electrolessly and/or electrolytically coatable particles are also magnetic or magnetizable. Alternatively, it is possible, for example, to use function pigments which are magnetic or magnetizable. It is also possible to use magnetic or magnetizable, electrolessly and/or electrolytically coatable particles and magnetic or magnetizable function particles. The magnetic or magnetizable particles may be ferromagnetic; for this purpose, it is possible, for example, to use an iron oxide (Fe₃O₄) or an iron powder with a particle size of more than 1 μm. It is also possible to use paramagnetic particles. For this purpose, it is possible, for example, to use iron oxide (Fe₃O₄) or iron powder with a particle size of less than 1 μm. According to the invention, the transfer of the electrolessly and/or electrolytically coatable particles or of the dispersion comprising the electrolessly and/or electrolytically coatable particles is promoted by applying a magnetic field. For this purpose, it is preferred to generate the magnetic field with a magnet arranged below the substrate to be coated. Alternatively, it is of course also possible to arrange the magnet above the substrate to be coated. Preference is given, however, to the arrangement below the substrate to be coated. In the case of use of magnetic or magnetizable particles or addition of magnetic or magnetizable particles to the dispersion, the particles are, or the dispersion is, transferred along the field lines of the magnetic field. This enables controlled transfer and improves the printed image. By virtue of the arrangement of the magnet below the substrate to be printed, the field lines of the magnetic field in the printed area run essentially parallel to the printing direction. This enables controlled printing of the substrate.

The magnets used, with which the magnetic field is generated, may be any desired magnet known to those skilled in the art. For instance, it is possible to use either permanent magnets or electromagnets. Preference is given to the use of electromagnets since they are switchable. A further advantage of electromagnets is that varying magnetic fields can be generated. This makes it possible, for example, to apply alternating magnetic fields and to adjust or to modify the intensity thereof according to the motif to be printed.

In contrast to electrostatically promoted printing, a further advantage of printing promoted by application of a magnetic field is that the substrate to be printed need not itself be a carrier of a charge, unlike an electrostatically charged substrate in the case of electrostatically promoted printing. The magnetic field lines may act over a relatively great distance through the substrate, without having any influence on the substrate. It is also possible to print substrates which consist of a metal or semiconductor, or comprise a metal or a semiconductor.

The promotion of the transfer by application of a magnetic field can additionally possibly reduce the laser energy needed for the transfer compared to processes without promotion by application of a magnetic field.

In one embodiment of the invention, the magnetic field is generated using an array with addressable magnet areas. This makes it possible to use varying magnetic fields or magnetic fields in different intensity. When the magnetic field is generated using an array with addressable magnet areas, a magnetic line is preferably installed directly below the print gap. This line is segmented into parts whose magnetic intensity can be controlled or reversed in polarity down to a fineness in print resolution. The magnetic field is preferably controlled digitally. The use of an array with addressable magnet areas makes it possible to match the magnetic field to the printed image to be generated.

After the application of the electrolessly and/or electrolytically coatable particles to the substrate, it is possible to coat the surface thus generated electrolessly and/or electrolytically after drying and/or curing. The coating achieves a continuous layer which can be used, for example, as a conductor track.

The process according to the invention is suitable, for example, for producing printed circuit boards, RFID antennas, transponder antennas, flat cables, chip card modules, seat heaters, foil conductors or conductor tracks in LCD or plasma visual display units. Working examples of the invention are shown in the figures and are explained in detail in the description which follows.

The figures show:

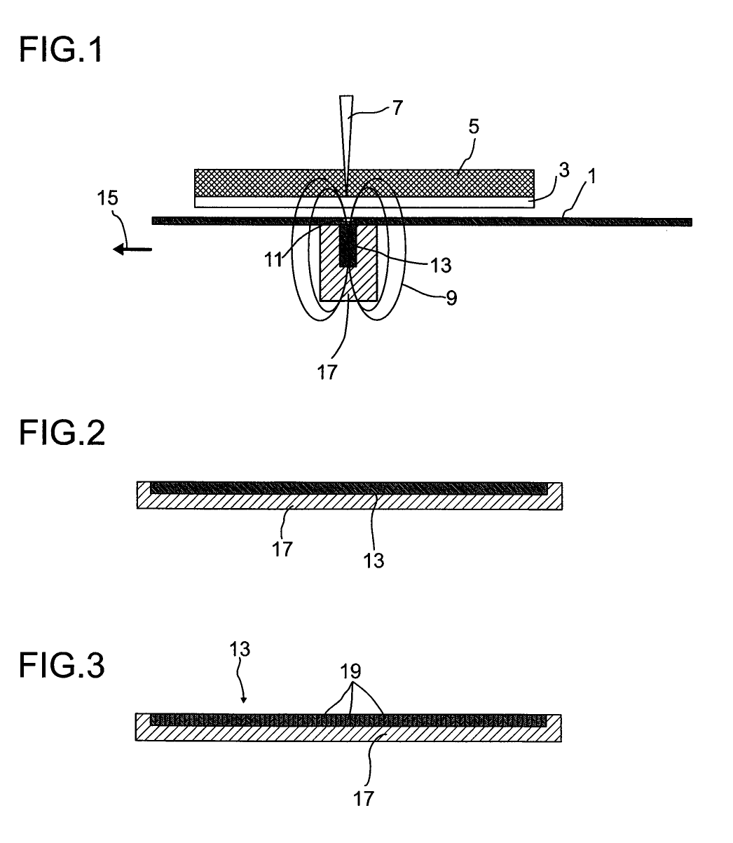

FIG. 1 a schematic diagram of the process according to the invention with one magnet,

FIG. 2 a schematic diagram of a single magnet,

FIG. 3 a schematic diagram of an array with addressable magnet areas.

FIG. 1 is a schematic diagram of the process according to the invention.

To print a substrate 1, electrolessly and/or electrolytically coatable particles or an electrolessly and/or electrolytically coatable dispersion 3 are transferred from a transfer medium 5 to the substrate 1. In order to transfer the electrolessly and/or electrolytically coatable particles or the dispersion 3 comprising electrolessly and/or electrolytically coatable particles from the transfer medium 5 to the substrate 1, energy is introduced into the electrolessly and/or electrolytically coatable particles or the dispersion 3 comprising the electrolessly and/or electrolytically coatable particles. The energy is introduced, for example, by a laser 7.

The energy introduced with the laser 7 at least partly evaporates the electrolessly and/or electrolytically coatable particles or the dispersion comprising the electrolessly and/or electrolytically coatable particles. As a result, the electrolessly and/or electrolytically coatable particles or the dispersion 3 comprising the electrolessly and/or electrolytically coatable particles become detached from the transfer medium 5 and are transferred to the substrate 1.

In order that the light from the laser 7 is converted to heat with which the electrolessly and/or electrolytically coatable particles or the dispersion 3 comprising the electrolessly and/or electrolytically coatable particles are at least partly evaporated, either the particles or the dispersion 3 comprising particles comprises a suitable absorber for the laser light. Suitable absorbers are, for example, carbon black, nanoparticulate metals such as silver nanoparticles, metal nitrides, metal oxides or fine lanthanum hexaboride with particle sizes in the range from 0.01 to 1 μm, preferably in the range from 0.02 to 0.5 μm and especially in the range from 0.03 to 0.2 μm.

According to the invention, the transfer of the electrolessly and/or electrolytically coatable particles or of the dispersion 3 comprising the electrolessly and/or electrolytically coatable particles is promoted by applying a magnetic field 9. To apply the magnetic field 9, a magnet 13 is positioned at the printing area 11, i.e. the area in which the electrolessly and/or electrolytically coatable particles or the dispersion 3 comprising the electrolessly and/or electrolytically coatable particles are transferred from the transfer medium 5 to the substrate 1. When the substrate 1 is printed line by line, the substrate 1 is moved transverse to the direction of line printing, as shown in FIG. 1 by an arrow 15. Each line is printed by moving the laser 7. In order to obtain magnetic promotion over the entire line width, the magnet 13 preferably extends over the entire line width to be printed.

In order to position the magnet 9, it is accommodated in a suitable holder 17.

Suitable magnets are both permanent magnets and electromagnets. Preference is given, however, to electromagnets since they are switchable and hence the strength of the magnetic field 9 can be adjusted. It is also possible to influence the printed image in this way. For example, by adjusting the magnet, it is possible to adjust the layer thickness to be printed and hence the intensity.

FIG. 2 shows a magnet in a holder in a first embodiment. In the embodiment shown in FIG. 2, a single magnet 13 is used. This means that a homogeneous magnetic field is generated over the entire line width to be printed.

A further embodiment is shown in FIG. 3. In the embodiment shown in FIG. 3, the magnet 13 is an array with addressable magnet areas 19. Each magnet area 19 is actuable individually, as a result of which the magnetic field can be modified digitally and dot by dot. The individual magnet areas 19 preferably correspond to the print resolution achievable with the laser 7. This allows the intensity of each individual dot to be printed to be adjusted in a controlled manner. The individual magnet areas 19 are preferably actuated by means of a suitable control unit.

### LIST OF REFERENCE NUMERALS

1 substrate
3 dispersion
5 transfer medium
7 laser
9 magnetic field
11 print area
13 magnet
15 movement of the substrate 1
17 holder
19 magnet area

1. A process for producing a structured or full-area, electrically conductive surface on a substrate, comprising:
transferring electrolessly coatable, electrolytically coatable, or electrolessly and electrolytically coatable particles, or a dispersion comprising the particles, from a transfer medium onto the substrate, and
fixing the particles on the substrate,
wherein the particles being are magnetic or magnetizable, and
the transferring comprises applying a magnetic field to the particles, thereby transferring them onto the substrate.

2. The process of claim 1, wherein the magnetic field is from a magnet below the substrate.

3. The process of claim 1, wherein the magnetic field is from an array comprising addressable magnet regions.

4. The process claim 1, wherein transferring the particles comprises introducing energy with a laser into the particles or the dispersion comprising the particles.

5. The process of claim 4, wherein the laser is a solid-state laser, a fiber laser, a diode laser, a gas laser, or an excimer laser.

6. The process of claim 4, wherein the laser generates a laser beam with a wavelength from 150 to 10,600 nm.

7. The process of claim 1, wherein the particles comprise a magnetizable material.

8. The process of claim 7, wherein the magnetizable material comprises iron, nickel, cobalt, NiFe, NiCuCo, NiCoFe, AlNi, AlNiCo, FeCoV, FeCo, FeSi, MnAlCu₂, SmCo, Nd₂Fe₁₄B, or a combination thereof.

9. The process of claim 1, comprising transferring a dispersion comprising the particles,
wherein the dispersion comprises an absorbent.

10. The process of claim 1, wherein the electrically conductive surface is coated electrolessly, electrolytically, or both after being dried, cured, or both.

11. The process of claim 1, wherein the transfer medium is a rigid or flexible plastic or glass which is transparent to the laser radiation.

12. A process for producing a printed circuit board, an RFID antenna, a transponder antenna, a flat cable, a chip card module, a seat heater, a foil conductor, or a conductor track in an LCD or plasma visual display unit, comprising the process of claim 1.

13. The process of claim 2, wherein the magnetic field is from an array comprising addressable magnet regions.

14. The process of claim 1, wherein a distance between the transfer medium and the substrate during the transferring is from 0 to 2 mm.

15. The process of claim 1, wherein the transfer medium is a film.

16. The process of claim 1, wherein a thickness of the transfer medium is from 1 to 500 μm.

17. The process of claim 1, wherein the transfer medium comprises at least one material selected from the group consisting of a polymer film and a glass cylinder.

18. The process of claim 1, wherein at least one component, selected from the group consisting of the transfer medium, the particles, or the dispersion, comprises an absorber capable of converting laser light into heat.

19. The process of claim 18, wherein the absorber comprises at least one absorber selected from the group consisting of carbon black, graphite, a carbon nanotube, graphene, a nanoparticulate metal, a metal nitride, a metal oxide, or a fine lanthanum hexaboride.

20. The process of claim 18, wherein a particle size of the absorber is from 0.01 to 1 μm.
